(19) United States
(12) Patent Application Publication
(10) Pub. No.: US 2026/0089382 A1
(43) Pub. Date: Mar. 26, 2026

(54) Versatile Perspective Control

(71) Applicant: Jan Kakos, Milevsko (CZ)

(72) Inventor: Jan Kakos, Milevsko (CZ)

(21) Appl. No.: 19/071,242

(22) Filed: Mar. 5, 2025

Related U.S. Application Data
(60) Provisional application No. 63/698,350, filed on Sep. 24, 2024.

(51) Int. Cl. H04N 23/58; H04N 23/55

(52) U.S. Cl. CPC H04N 23/58; H04N 23/55

(57) ABSTRACT

The present invention relates to a device combining a tiltable image sensor with rotating and sliding lens assembly, which enables dynamic control of perspective in camera applications. The system utilizes gyroscope-based control, allowing the image sensor to retain any given orientation as per the desired composition or to avoid distortion in a specified direction. A bi-axial movement mechanism enables full perspective control along all possible directions, limited only by the systems range of motion. The rotating and sliding lens assembly adjusts both its orientation and position in coordination with the sensor's tilt. This ensures that the focal plane remains correctly aligned with the tilted sensor. Additionally, a partial movement control configuration is disclosed, wherein one axis of rotation is removed and supplemented by manual user-controlled movement. A circular image sensor is introduced to compensate for sensor misalignment, with a variable square capture area selected based on the sensor's position.

### PRIORITY CLAIM

This nonprovisional application claims the benefit of U.S. Provisional Application No. 63/698,350, filed on Sep. 24, 2024. The complete disclosure of the provisional application is hereby incorporated by reference in its entirety.

### REFERENCES

JP2024057829A—Canon, inventor Shuhei Ono (see also: “Canon Patent Application: Camera with Internal Tilt Movement” an online article by Canon Rumors)
US20210344840A1—inventor Giovanni Sacco

### SUMMARY OF THE INVENTION

The present invention introduces a tiltable image sensor system that dynamically controls perspective distortions by adjusting the sensor's orientation in real time. Unlike conventional camera systems where perspective correction is limited by fixed optical components, this invention allows for automatic or manual sensor tilting, providing greater control over image composition and perspective alignment.

The system incorporates gyroscope-based control, enabling the image sensor to retain any given direction as per the desired composition or to avoid distortion in any specified direction, most notably vertical distortion. To ensure complete directional coverage, the system utilizes bi-axial sensor movement, allowing full perspective control along all possible directions, limited only by the system's range of motion.

The invention introduces a rotating and sliding lens assembly that adjusts both its orientation and position in coordination with the sensor's tilt. This ensures that the focal plane remains correctly aligned with the tilted sensor.

A simplified variation of the system, termed Partial Movement Control, eliminates one axis of rotation, replacing it with manual user-controlled rotation. To compensate for sensor misalignment caused by this change, the system can employ a circular image sensor, where an active square capture area is selected based on the sensor's position. A computational adjustment is applied to ensure the pixel grid remains correctly oriented for display and processing.

By combining real-time sensor tilting, bi-axial movement, and an adaptive rotating and sliding lens assembly, the present invention expands creative control, improves usability, and enhances perspective control, making it particularly beneficial for architectural photography, cinematography, and other applications requiring precise perspective management.

### BRIEF DESCRIPTION OF DRAWINGS

FIG. 1A is schematic geometric projection, showing photographer taking picture of a house, pointing a camera under an angle in horizontal direction without using correction, where letter F refers to the Photographer, label FC marks closeup of the photographer holding a camera with tilt-shift lens and label PP marks projection plane (which records same perspective as image sensor would)

FIG. 1B is schematic geometric projection, showing photographer taking picture of a house, pointing a tilt-shift camera under an angle in horizontal direction shifting the lens and rotating the camera for perspective correction, where letter F refers to the Photographer, label FC marks closeup of the photographer holding a camera with tilt-shift lens and label PP marks projection plane (which records same perspective as image sensor would)

FIG. 1C is schematic geometric projection, showing photographer taking picture of a house, pointing a tilt-shift camera under more extreme angle in horizontal direction, shifting the lens, rotating the camera and changing his stance to perform perspective correction, where letter F refers to the Photographer, label FC marks closeup of the photographer holding a camera with tilt-shift lens and label PP marks projection plane (which records same perspective as image sensor would)

FIG. 1D is schematic geometric projection, showing photographer taking picture of a house, pointing a tilt-shift camera under more extreme angle, both in horizontal and vertical direction, without using correction, where letter F refers to the Photographer, label FC marks closeup of the photographer holding a camera with tilt-shift lens and label PP marks projection plane (which records same perspective as image sensor would)

FIG. 2 illustrates how gyroscope-controlled image sensor would compensate for upward tilt of the camera to eliminate distortion of vertical lines.

FIG. 3 shows a scenario of photographer trying to record a bird mid-flight, wishing to control vertical distortion with typical tilt-shift lens.

FIG. 4 schematically shows image sensor having two axes of rotation.

FIG. 5A is schematic geometric projection, showing a photographer taking a picture of a church and houses arranged around a square, without using a perspective control, where letter F refers to the Photographer and label PP marks a projection plane (which records same perspective as image sensor would)

FIG. 5B is schematic geometric projection, showing a photographer taking a picture of a church and houses arranged around a square, while tilting the image sensor, where letter F refers to the Photographer and label PP marks a projection plane (which records same perspective as image sensor would)

FIG. 6 shows overlay of two images taken from the same standing point but one is taken with naturally positioned image sensor and other with tilted image sensor.

FIG. 7 shows that having the same axis of rotation for lens and image sensor would result only in pointing the camera in different direction.

FIG. 8A shows schematic illustration of tilting the image sensor simultaneously with tilting of the lens

FIG. 8B shows schematic illustration of tilting the image sensor simultaneously with tilting of the lens, while the lens size is deliberately increased to allow light pass to the sensor while the lens is tilted

FIG. 9 Illustrates removing material from 2 opposing sides of the lens assembly in order to reduce weight of the lens.

FIG. 10 illustrates that as the lens assembly rotates it also needs to slide further away from the image sensor, so the projected image is properly aligned with the sensor.

FIG. 11 shows that if rectangular outer frame was used for the bi-axial image sensor, at larger angles of rotation, the frame would block some light traveling to the sensor.

FIG. 12 shows a special design for the outer frame of bi-axial image sensor.

FIG. 13 shows how a special design of outer frame of the bi-axial image sensor wouldn't block any light traveling to the sensor.

FIG. 14A Shows simplified drawing of camera body and rotating lens assembly, illustrating the point, that out of 2 axes of rotation, only one axis can be of the same direction as the axes of the image sensor; letter L marks light traveling toward the lens assembly

FIG. 14B Shows simplified drawing of camera body and rotating lens assembly, illustrating that second axis of rotation of the lens assembly can be placed in the third dimension relative to the axes of the image sensor; letter L marks light traveling toward the lens assembly

FIG. 15A-F shows the side view of Design 1 of the Rotating Lens Assembly

FIG. 15B shows the front view of Design 1 of the Rotating Lens Assembly

FIG. 15C shows the axonometric view of Design 1 of the Rotating Lens Assembly

FIG. 15D shows the top view of Design 1 of the Rotating Lens Assembly

FIG. 15E shows the axonometric view of Design 1 of the Rotating Lens Assembly, while rotating the lens around one axis

FIG. 15F shows the axonometric view of Design 1 of the Rotating Lens Assembly, while rotating the lens around two axes

FIG. 16 is an axonometric view with reference numerals of the Design 1 of rotating lens assembly

FIG. 17 explode view of Design 1 of the Rotating Lens Assembly

FIG. 18A shows the side view of Design 2 of the Rotating Lens Assembly

FIG. 18B shows the front view of Design 2 of the Rotating Lens Assembly

FIG. 18C shows the axonometric view of Design 2 of the Rotating Lens Assembly

FIG. 18D shows the top view of Design 2 of the Rotating Lens Assembly

FIG. 18E shows the axonometric view of Design 2 of the Rotating Lens Assembly, while rotating the lens around one axis

FIG. 18F shows the axonometric view of Design 2 of the Rotating Lens Assembly, while rotating the lens around two axes

FIG. 19 is an axonometric view with reference numerals of the Design 1 of rotating lens assembly

FIG. 20 illustrates the lens assembly having spherical contact surface with the chamber, which lies between the lens and the image sensor

FIG. 21 show axonometric view of Design 2 of the rotating lens assembly with included handles extending from the camera body for better ergonomics

FIG. 22 shows axonometric view of Design 2 of the rotating lens assembly with alternative way to address ergonomics, by moving the camera body closer to the center of mass and extending the sides of the camera body to the center of mass.

FIG. 23 illustrates that if we put one axis of rotation on the optical axis, usable area of square image sensor would be decreasing as the sensor rotates

FIG. 24A shows a schematic illustration of a circular image sensor

FIG. 24B shows rotated circular image sensor, showing that the square pixel grid is no longer horizontal and vertical

FIG. 25 shows, how the axes and angles of rotation of the lens assembly and the image sensor, were named

FIG. 26 Shows angle ε, marking the rotation of image frame on the circular image sensor

### BACKGROUND OF THE INVENTION

Cameras generally capture the world in linear perspective, which, except of one viewing angle, causes parallel lines to converge, distorting rectangular shapes into trapezoidal projections. This distortion-free viewing angle occurs, when the image sensor is perfectly parallel to the rectangular subject being captured, meaning the camera's viewing angle is precisely perpendicular to the subject. As the viewing angle deviates from perpendicular to a more oblique orientation, the projected trapezoidal distortion becomes more pronounced. This effect is often undesirable, particularly in architectural photography, where vertical lines of buildings appear to converge rather than remain parallel.

To address this issue, tilt-shift lenses were introduced. These lenses allow photographers to correct vertical line convergence by shifting the optical axis, maintaining a more natural appearance in architectural images. While effective in correcting vertical distortions, tilt-shift lenses have significant limitations and do not fully exploit the potential for controlling the projection of three-dimensional space onto two-dimensional images or video.

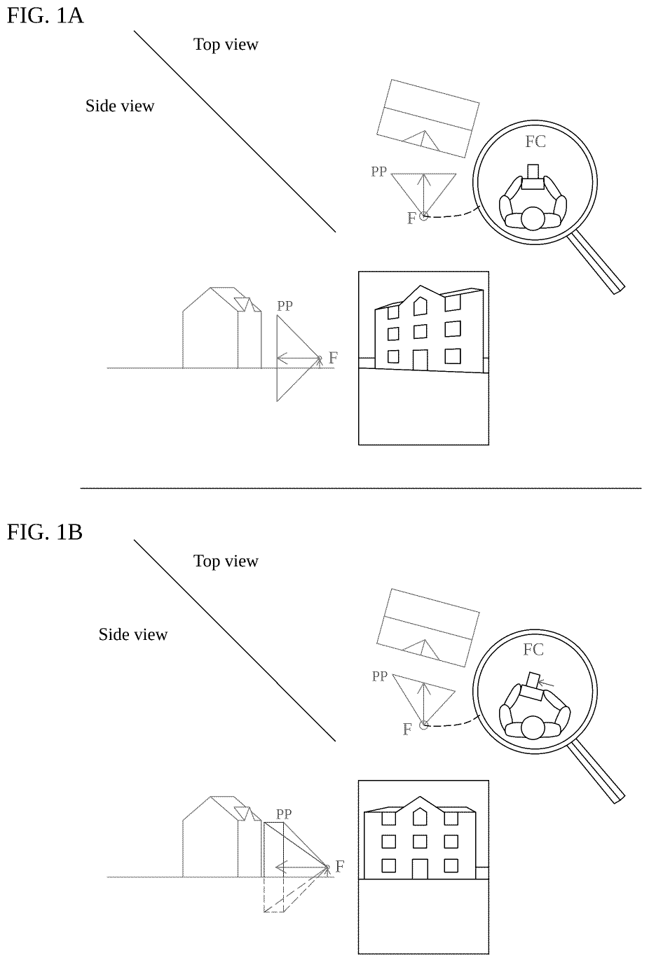

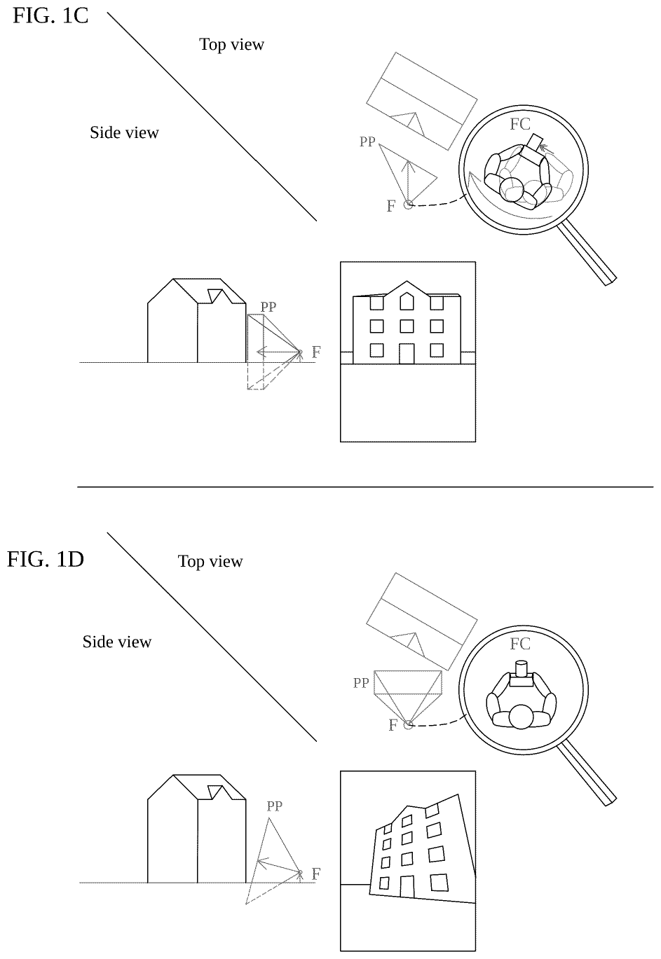

One such potential improvement is the ability to control distortion in any direction, not just vertical lines. Some of this potential can be achieved with tilt-shift lenses, but this introduces additional constraints and difficulty of use for the tilt-shift lenses. For instance, consider a scenario where a photographer captures the front face of a building from an angled viewpoint. Initially, the building appears slightly distorted (FIG. 1A). By rotating the camera body to align the sensor parallel to the building's face and shifting the tilt-shift lens laterally, the distortion can be corrected (FIG. 1B).

However, as the viewing angle increases, the photographer must rotate the camera even further, requiring an adjustment of their physical stance to properly view the camera's display (FIG. 1C). The challenge intensifies when the building is taller, necessitating an upward tilt of the camera to include the entire structure in the frame. This adjustment introduces simultaneous horizontal and vertical distortions (FIG. 1D), requiring a complex sequence of actions: camera rotation, stance adjustment, lens shifting, and fine-tuning of tilt angles to achieve an acceptable correction.

These limitations highlight the need for a more efficient and intuitive method of distortion correction. The present invention addresses this challenge by allowing photographers to correct distortions across multiple directions with a single movement and the click of a button, significantly simplifying the process while enhancing creative control over perspective correction.

### DETAILED DESCRIPTION OF THE INVENTION

### Primary Principle of the Design

The principle of the present invention is tilting the image sensor to control the perspective.

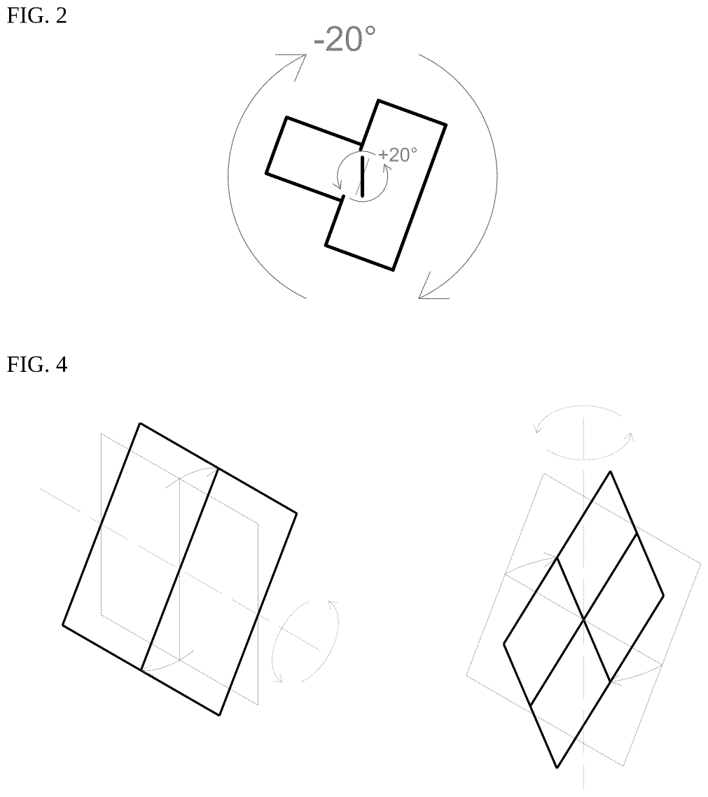

For example, when a photographer captures an image of a tall building, the natural tendency is to tilt the camera upward to fit the structure within the frame. This results in vertical line convergence due to perspective distortion. To correct this, the image sensor tilts in the opposite direction of the camera's tilt, effectively maintaining the intended proportions of the subject. As illustrated in FIG. 2, when the camera tilts 20 degrees upward, the sensor tilts 20 degrees downward, neutralizing vertical distortion.

While this adjustment could be manually controlled by the user, the system incorporates a gyroscopic sensor that detects the camera's tilt angle and automatically adjusts the image sensor. This automated adjustment simplifies operation, eliminating the need for manual perspective correction and enabling intuitive composition.

### Real-Time Perspective Control for Video Applications

In addition to improving still photography, the invention provides superior performance for video applications. Traditional tilt-shift lenses are inherently limited in video use, as they can only correct distortions in one fixed direction. For instance, while a tilt-shift lens can compensate for horizontal distortion, it is unable to dynamically adjust for vertical perspective shifts in real-time.

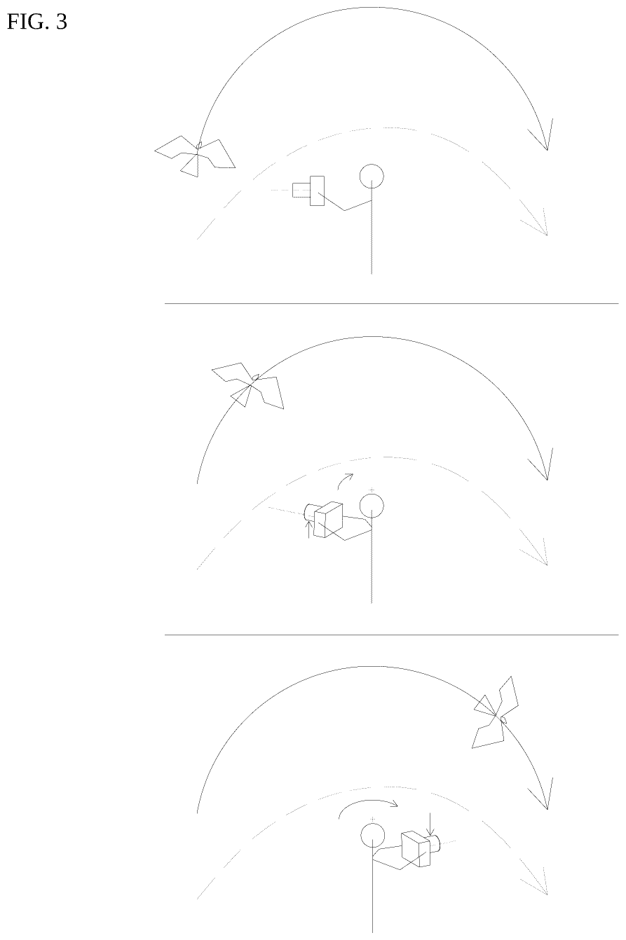

Consider the scenario of filming a bird in flight. FIG. 3 Using a traditional tilt-shift system, a videographer would need to manually shift the lens while simultaneously rotating the camera to maintain the subject within the frame. Even if motorized servos controlled the lens movement, achieving smooth and consistent framing would be challenging.

With the proposed invention, the photographer simply enables vertical correction mode, allowing the gyroscopic system to dynamically adjust the sensor's tilt as needed. As the bird ascends or descends, the photographer naturally follows it by tilting the camera, while the sensor automatically compensates to maintain proper perspective. This significantly reduces the need for complex manual adjustments, ensuring seamless tracking and distortion-free video capture.

### Application of Multi-Axis Sensor Control to Solve Perspective Distortion in FIG. 1C

The invention is particularly suited to address the perspective distortion encountered in the scenario illustrated in FIG. 1C, where the camera is positioned at a significant angle to the subject. In such cases, maintaining correct perspective requires compensating for distortion in both horizontal and vertical directions.

The same gyroscope-based stabilization system that ensures the sensor maintains a vertical correction can also be extended to preserve alignment in any other given direction. To achieve this, the system incorporates a second axis of rotation to the image sensor, as shown in FIG. 4. Through the combined ability to rotate along both horizontal and vertical axes, the sensor can be dynamically adjusted to point in any desired direction, ensuring proper alignment with the subject's reference plane.

To apply this functionality in the context of FIG. 1C, the process proceeds as follows:
1. Initial Alignment: The user first positions the camera so that the image sensor is parallel to the building's facade, establishing a distortion-free reference perspective.
2. Saving the Orientation: The system allows the user to store this reference direction, effectively locking the sensor's alignment relative to the subject.
3. Repositioning the Camera: With the reference saved, the user can then freely move the camera to the desired shooting position and angle.
4. Automatic Compensation: As the camera is repositioned, the gyroscopic stabilization system continuously adjusts the sensor's tilt and rotation to maintain alignment with the saved reference direction, ensuring that the final image remains free from perspective distortion.

By utilizing multi-axis sensor control, the system enables real-time and automated perspective correction for complex shooting scenarios, significantly improving usability and eliminating the need for intricate manual adjustments.

### Perspective Control Through Plane Adjustment

There is one more perspective control feature this invention enables, which has enormous untapped potential. We can realize that as we control lines, sets of lines create planes. So, by controlling lines, we are also able to control planes, determining how much space a face lying on a plane occupies within the image frame. Controlling this can hugely influence the composition of shots.

In many scenarios, a photographer is restricted to a specific shooting position, even when a different vantage point would offer a more compositionally balanced shot. By tilting the image sensor, the system allows for greater compositional flexibility, helping to approximate a more ideal framing even from a less-than-optimal position.

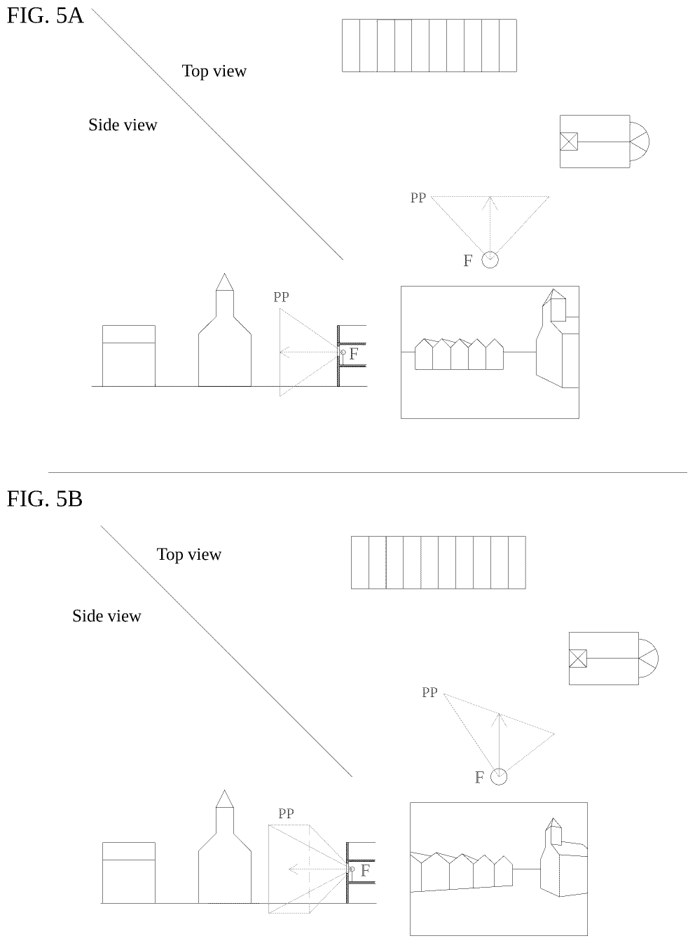

As an example, consider the scenario depicted in FIG. 5A, where the photographer is positioned inside a building on the corner of a town square, taking a photo through a window. In this image, the townhouses across the square appear with undistorted facades, while the church, located at the side of the square, appears disproportionately large due to the forced perspective. The front facade of the church is distorted, while its side facade maintains its correct proportions. This creates a visual dissonance, as the two sides of the church exhibit a noticeable difference in perceived scale.

A possible adjustment would be to reorient the camera toward the church, but doing so would significantly reduce the portion of the town square visible in the frame. Instead, by tilting the image sensor, as shown in FIG. 5B, the townhouses become more prominent in the frame, while the church is visually reduced in scale, balancing their relative proportions.

Although this adjustment does not eliminate all distortions, it redistributes them in a way that enhances the overall harmony of the composition. The townhouses become slightly more distorted, but the front and side facades of the church align more naturally, creating a more visually cohesive result. This effect is particularly noticeable when comparing the church tower in both images: in FIG. 5A, the tower appears elongated, whereas in FIG. 5B, it appears more natural.

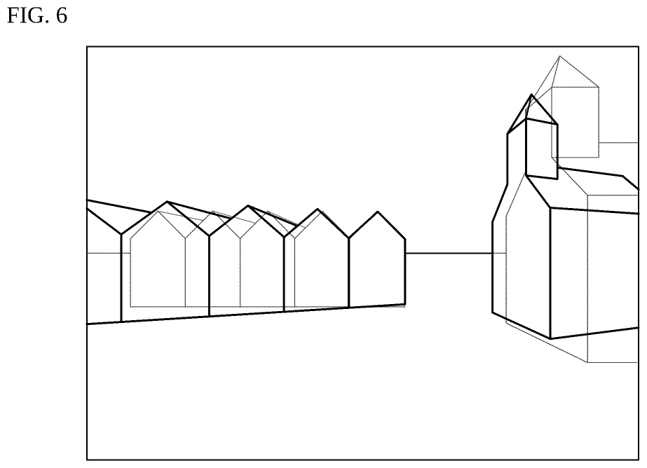

To further illustrate this transformation, FIG. 6 presents an overlay of both images, visually demonstrating the impact of sensor tilting on spatial balance and compositional refinement.

### Focus Adjustments

Conventional lens systems are designed to project a sharp image onto a sensor or film positioned on a flat plane perpendicular to the optical axis. However, when the image sensor is tilted, it no longer aligns with this optimal plane of focus, requiring a corresponding adjustment to ensure that the image remains sharp.

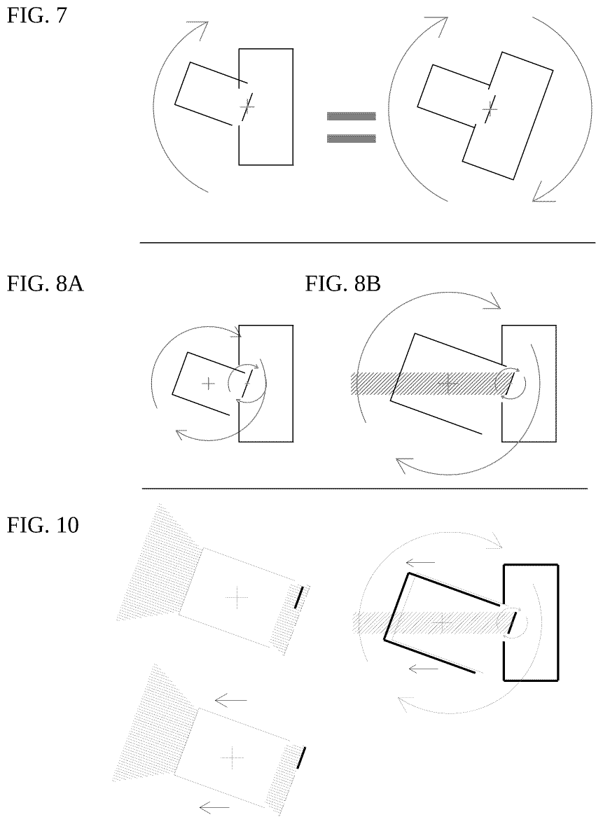

To address this issue, the invention incorporates a method for tilting the plane of focus along with the sensor. This is achieved by moving the entire lens assembly in conjunction with the sensor. However, the lens assembly and sensor cannot share the same center of rotation (FIG. 7), as doing so would result in the same effect as simply rotating the entire camera, which would just be the same as pointing the camera in another direction.

Instead, the center of rotation of the lens assembly is positioned within the center of the lens assembly, as shown in FIG. 8A. This allows the optical projection to remain aligned with the tilted sensor while maintaining a consistent focal plane. However, a significant consideration in this approach is that as the lens system rotates, its size must increase to ensure that the sensor remains within the image circle of the projected light.

If the lens system is designed to allow rotation up to 30 degrees in either direction, it would require an increase in size by approximately two times the original dimensions (FIG. 8B). However, it is important to note that this size increase is only necessary in one dimension, while the width of the lens system can remain unchanged. This can be visualized as removing sections from opposite sides of the lens system, as illustrated in FIG. 9.

In practical application, these cuts would not be straight but instead would follow a U-shaped pattern, corresponding to the path light takes through the lens system. This modification, when combined with a smaller image sensor, significantly improves the manageability of the system's proportions.

However, an additional challenge arises from the fact that as the lens assembly grows larger, its volume—and consequently its weight-increases disproportionately. In the lens assembly used as an example in the figures, the required modifications would result in a fivefold increase in the weight of the glass components. This necessitates lighter alternatives to traditional glass lenses to maintain practical usability.

### Potential Solutions Include:

Polycarbonate lenses, which can be up to two times lighter than glass, reducing the overall weight increase from 5× to approximately 2.5×.
Lens designs requiring fewer elements, which would further reduce weight while maintaining optical performance.

By integrating these adjustments, the invention ensures that focus is maintained dynamically when tilting the image sensor, while also addressing practical limitations related to lens size and weight.

When the lens system and the image sensor each rotate around their own axes, the image circle becomes parallel to the sensor, but is not yet fully aligned. To complete the adjustment, the lens system must be moved slightly forward, as illustrated in FIG. 10.

The precise amount of this forward movement is determined by a mathematical formula, which is provided in the section Formulas.

### Bi-Axial Sensor Mechanism

To achieve full directional control, the image sensor requires two axes of rotation, which is implemented using a dual-frame system. This consists of:
1. An outer frame, which rotates around one axis.
2. An inner frame, which holds the sensor and rotates around the second axis.

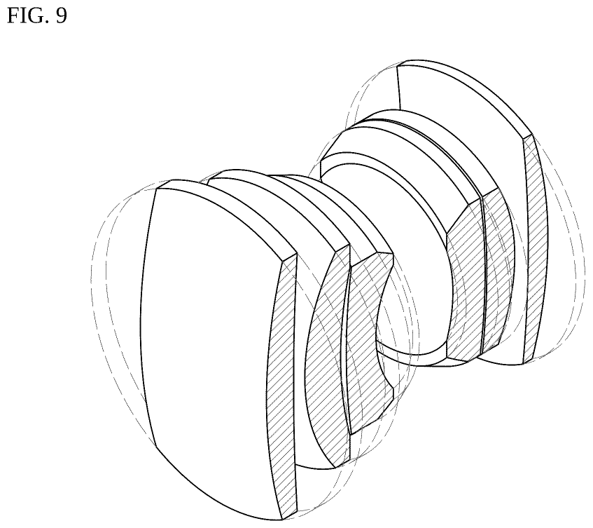

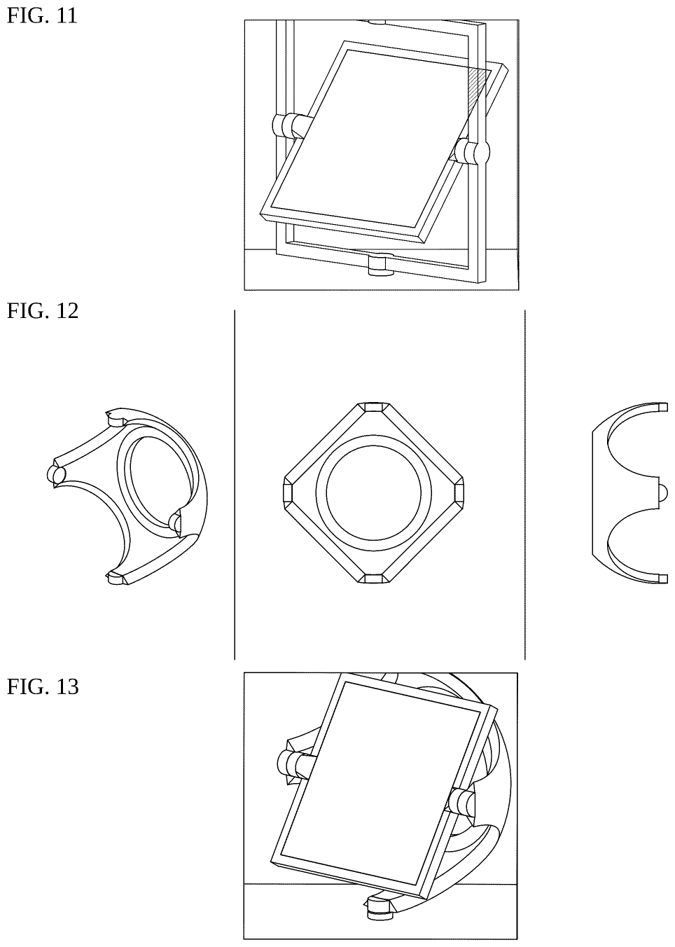

However, when both frames rotate at larger angles, the outer frame can obstruct incoming light, preventing it from reaching the sensor, as illustrated in FIG. 11.

One possible solution to this issue is to increase the size of the outer frame to allow unobstructed light passage. However, this approach would require a larger internal space within the camera body to accommodate the expanded frame. Instead, the issue can be resolved by modifying the shape of the outer frame, as shown in FIGS. 12 and 13. By adopting a revised frame geometry, the system ensures that light can reach the sensor without obstruction, while maintaining a compact and efficient design within the camera body.

Covering All Directions with a Rotating Lens Assembly

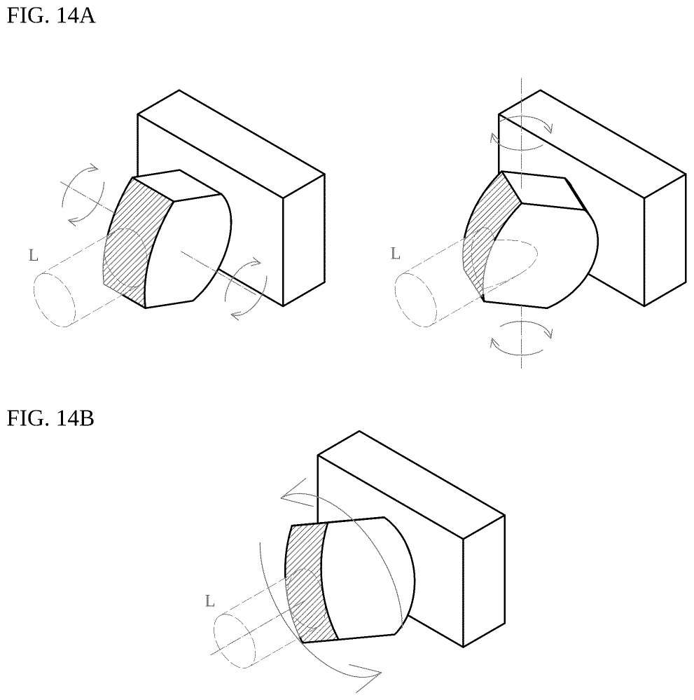

The lens assembly can't cover all directions by using axes of the same direction as axes of the sensor as shown in FIG. 14A, because rotating it this way wouldn't let all of the light pass to the sensor. Instead, only the axis for the allowed direction of rotation, which is determined by the lens cut geometry (FIG. 9), is retained, while the second axis is placed in the third dimension. To elaborate, if you were to name directions of axes of the sensor x and z. Axes of the lens system would be in direction x and y. This y axis would also align with the optical axis in default position. This approach will allow to keep the lighter lens assembly, while enabling light to pass to the sensor in all directions. FIG. 14B

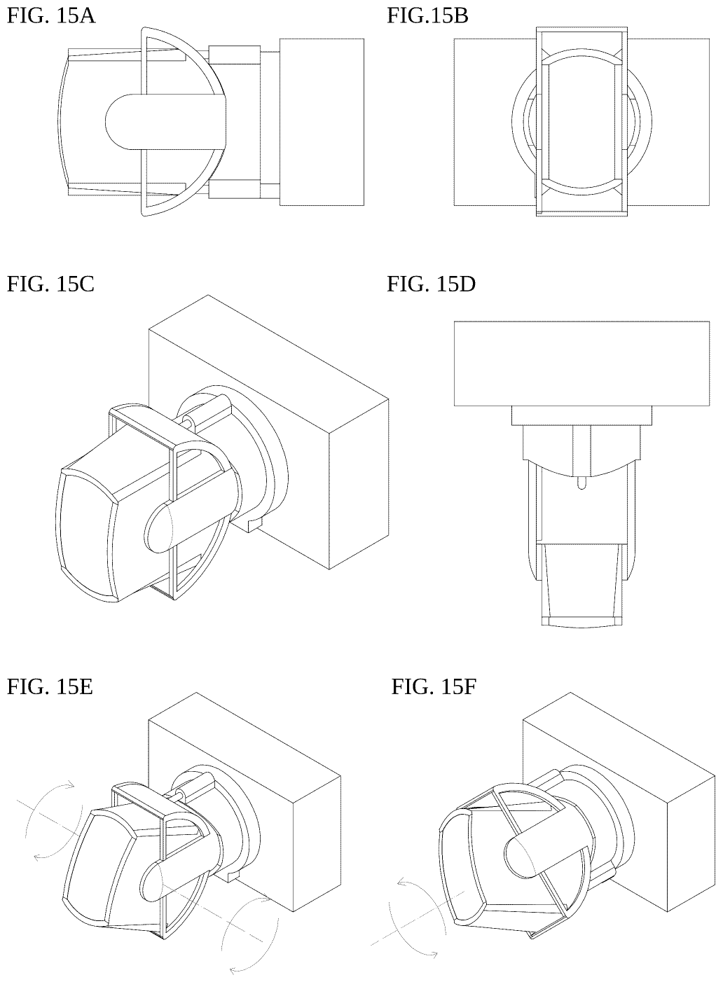

### Rotating Lens Assembly—Design 1 (FIG. 15-17)

1—case, holding the lenses
2A—arms holding the lens case
2B—arms transitioning into an inner cylinder sliding inside outer cylinder, covering chamber between lenses and sensor
3—shield, covering back side of the lens assembly
4—outer cylinder
5—direct drive linear motor fixed to the outer cylinder
6—“piston” of the linear motor, moving the lens assembly back and forth
7—motor on each side rotating the lens assembly around x axis
8—ring, covering gear teeth on outer cylinder, ring is fixed to the camera body
9—Case connected to the ring, holding motor driving the outer cylinder through worm gear
10—camera body
11—lens

In the drawings, the use of electric servos and actuators is assumed. The proportions are conceived to accommodate these motors, and the drawings illustrate an optimal placement configuration.

If only the necessary volume of space between the lens assembly and the sensor is enclosed, if the lens assembly rotates, the lens on the back side would get partially exposed to light. While primary light will not reach the image sensor through this exposed area, there is a potential risk of internal reflections occurring within the lens assembly.

This issue remains an unexplored topic, but the proposed designs incorporate measures to mitigate or completely eliminate this potential problem.

In Design 1, a shielding system is employed to cover the entire range of lens movement, ensuring that the back side of the lens assembly remains fully enclosed at all times. The shield has a cylindrical shape, with its axis aligned with the axis of rotation of the lens assembly. The shield follows the path of the outermost point on the lens assembly with the largest diameter, relative to its axis of rotation.

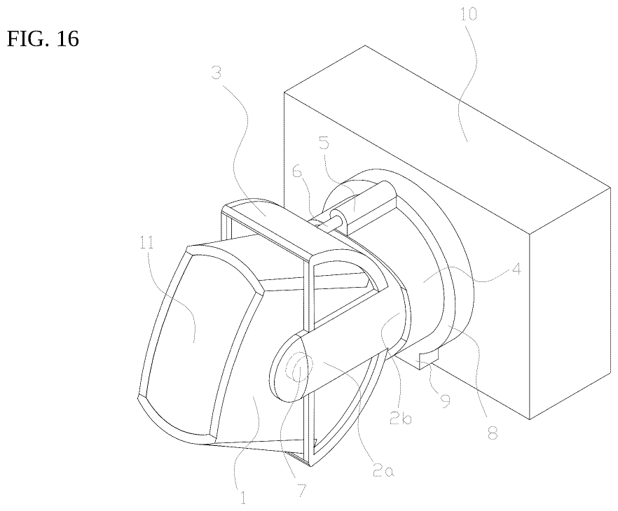

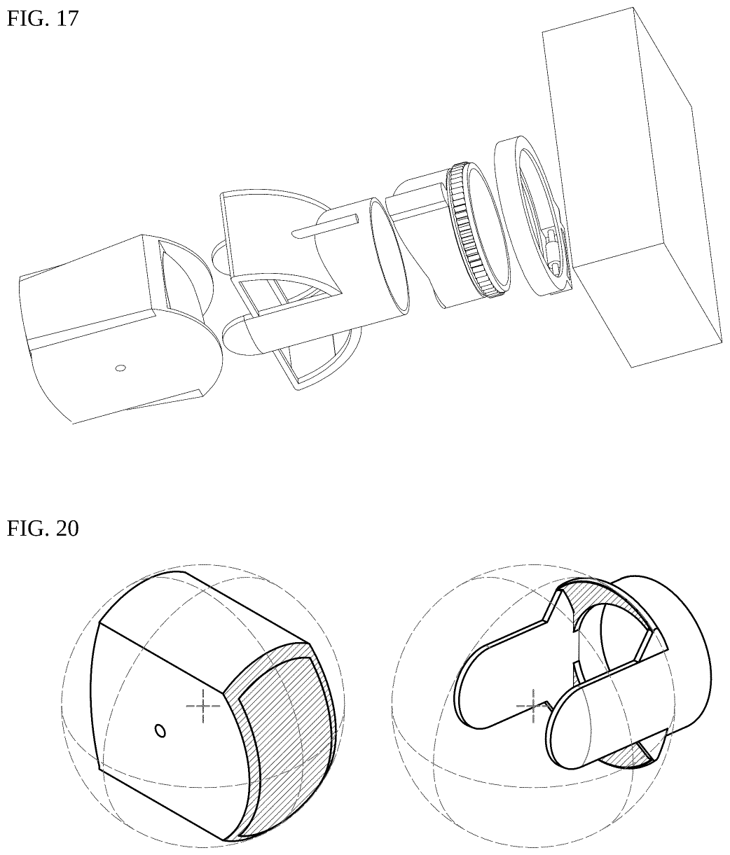

To further prevent light leaks, the lens housing itself incorporates two additional shielding elements on each side, which are designed to block any potential openings. These shielding parts are visible in the exploded view illustrated in FIG. 17.

Although electric motors maximize the benefits of this system, both in design 1 and design 2, particularly when integrated with a gyroscopic sensor, the movement of the lens assembly can also be controlled partially or fully manually. In such cases, the photographer would determine the necessary rotations for composition and then adjust the lens assembly forward and backward manually to achieve proper focus.

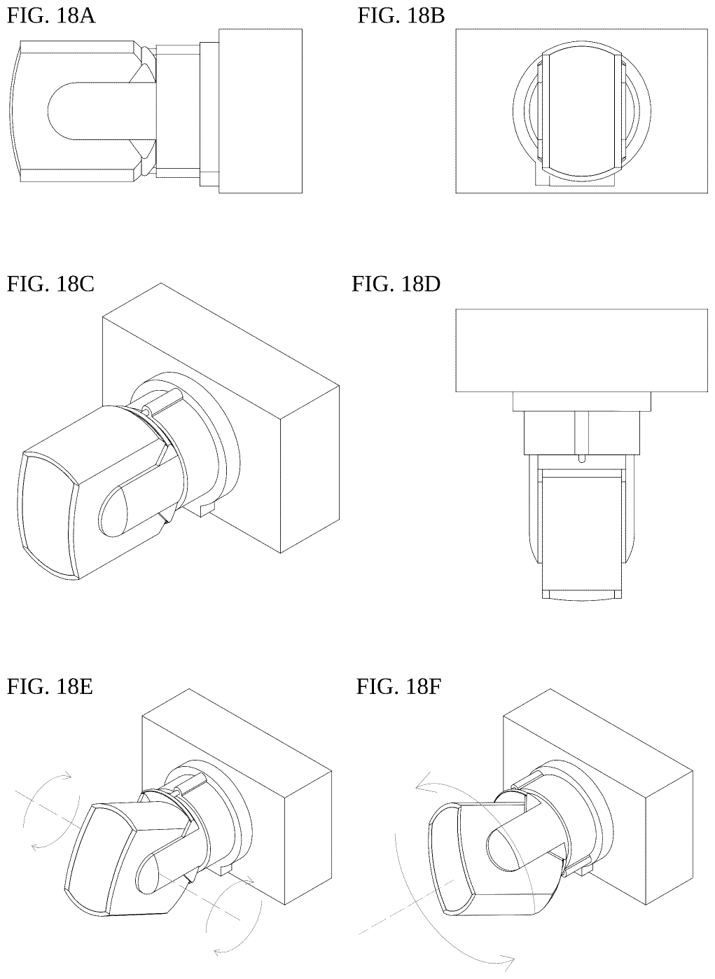

### Rotating Lens Assembly—Design 2 (FIG. 18, 19)

1—case, holding the lenses
2A—arms holding the lens case
2B—arms transitioning into an inner cylinder sliding inside outer cylinder, covering chamber between lenses and sensor
3—extension of spherical contact surface between inner cylinder and lens
4—outer cylinder
5—direct drive linear motor fixed to the outer cylinder
6—“piston” of the linear motor, moving the lens system back and forth
7—motor on each side rotating the lens system around x axis
8—ring, covering gear teeth on outer cylinder, ring is fixed to the camera body
9—Case connected to the ring, holding motor driving the outer cylinder through worm gear
10—camera body
11—lens

One disadvantage of Design 1 is that the large shield may not be aesthetically appealing. An alternative approach is to utilize a reflective coating on the exposed back side of the lens assembly, which could sufficiently prevent unwanted internal reflections. This modification allows for a design without the shield, improving visual appearance while maintaining optical performance.

However, without the shield, certain structural adjustments must be made to ensure that the chamber between the image sensor and the lens assembly remains completely dark. This requires the rotating lens assembly to be in direct contact with the chamber, eliminating any gaps where light could enter.

In Design 1, this light-sealing contact was achieved between the shield extending from the chamber and the lens housing. However, without the shield in Design 2, the exposed back lens itself must be in direct contact with the chamber to seal the gap and prevent light leakage.

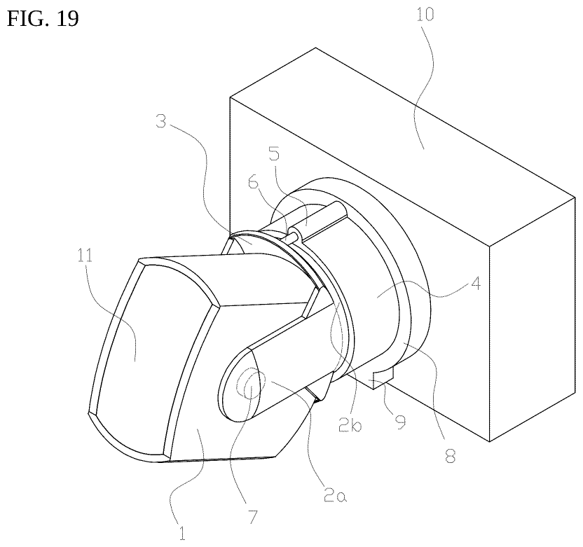

To accomplish this, the center of the spherical face of the exposed lens must be aligned with the rotation axis of the lens assembly. Additionally, the contact face of the chamber must be designed to follow the same spherical shape, ensuring a continuous seal throughout the lens movement. This configuration is illustrated in FIG. 20.

### Ergonomics

One additional consideration for both Design 1 and Design 2 is ergonomics. It is a case for many cameras, that the center of mass of the device does not lie within the camera body itself but within the lens assembly. As a result, photographers typically support the lens assembly with their hand while holding the camera.

However, in this case, the lens assembly is motorized, meaning that directly supporting it with the hand would hinder its movement, creating unnecessary strain on the motors.

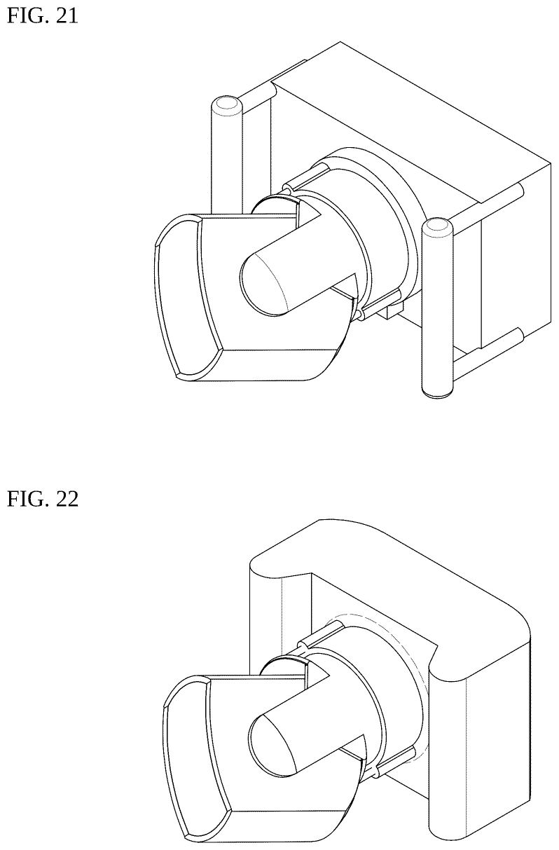

A solution to this issue is to extend a supporting element from the camera body to align with the center of mass. This can be achieved in two ways:
1. Attaching external handles to the camera body, as illustrated in FIG. 21.
2. Integrating the outer ring (FIGS. 19-8) into the camera body, effectively shifting the entire camera body closer to the center of mass. In this configuration, the handles would also become a part of the camera body, as shown in FIG. 22.

Additionally, if we move the camera body closer to the center of mass, the image sensor moves with it. As a result, the field of focus would need to be positioned closer to the lens assembly to maintain proper optical alignment.

### Partial Movement Control

An alternative approach to full-axis motorized control is to remove one axis of rotation and instead supplement it with manual rotation around the Y-axis, controlled directly by the photographer. This modification would simplify the construction, reducing both mechanical complexity and the number of required motors by two.

The trade-off for this design is that automatic gyroscopic control would no longer be available for all directions. Instead, the system would retain automatic correction only for the vertical distortion control. However, this would be one of the most common use cases for perspective correction, making this simplified approach a practical alternative.

To make this lighter and less complex design fully functional, two additional problems must be addressed:

### P1: Maintaining a Consistent Usable Image Area

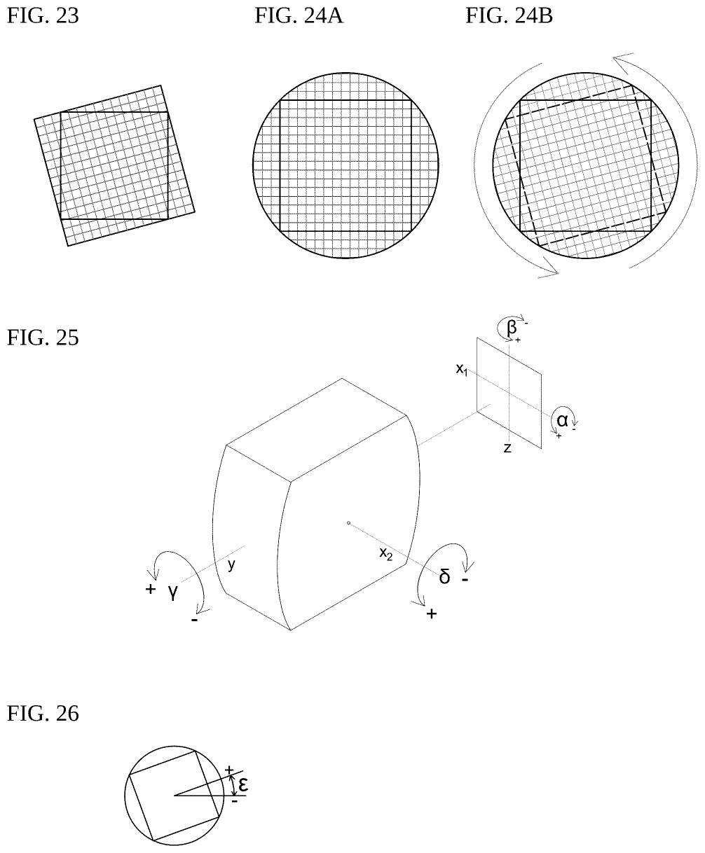

With partial movement control, the remaining axes of rotation are along the X-direction, while manual movement is performed around the Y-axis. But, as you can see in the FIG. 23, as the image sensor rotates around the Y-axis, its edges no longer remain vertical and horizontal. This results in a reduced usable image area, limiting the effective capture region to a smaller square cut within the sensor.

To eliminate this drawback, the system can utilize a circular image sensor instead of a traditional square sensor, as shown in FIG. 24A. In this configuration, at each different tilt position of the sensor, a square region within the circular sensor is activated, always aligning with the intended frame orientation. This ensures that, regardless of the sensor's tilt direction, the usable image area remains the same.

P2: Aligning the Pixel Grid with the Image Frame

As the square capture region rotates within the circular sensor, the individual pixels do not physically rotate with it. As a result, the pixel grid of the captured image does not remain aligned with the vertical and horizontal grid of displays, as illustrated in FIG. 24B. Fortunately, this misalignment can be easily corrected. The realignment of the pixel grid is equivalent to the image rotation function used in photo editing software. Therefore, the same algorithms used for image rotation can be implemented to adjust the pixel alignment.

### FORMULAS

### FIG. 25, 26

Horizontal axis of the image sensor is marked x₁, sensor rotates about this axis by angle α Vertical axis of the image sensor is marked z, sensor rotates about this axis by angle β

Lens assembly has both axes horizontal, one parallel with x₁ is marked x₂, axis perpendicular to x₂ is marked y.

Rotation about axis y is marked γ, rotation about axis x₂ is marked δ

Image sensor is the component that controls the perspective, so its rotation angles α and β, are inputs while angles γ and δ move according to following formulas:

$$\begin{matrix}\underline{γ = {tan}^{- 1}} \\ \underline{δ = {tan}^{- 1}}\end{matrix}$$

[(cos (α) sin (β)/sin (α)]
[tan (β)/sin (γ)]

Forward movement adjustment of tilted lens assembly is marked e, distance of axis x₂ from center of the image sensor in default position is marked I:

$$\underline{e = 1 / cos ( δ ) - 1}$$

In design with partial movement control, the image frame has to rotate on the image sensor.

$$\underline{ε = - {tan}^{- 1}}$$

[tan (γ)/cos (α)]

1. A Device for Perspective Control Using a Rotating Image Sensor and Rotating & Sliding Lens Assembly
A camera system for dynamic perspective control, comprising:
A tiltable image sensor configured to rotate around at least two axes to maintain a desired orientation for composition control or distortion correction;
A gyroscopic sensor operatively coupled to the image sensor, configured to detect the camera's tilt and adjust the orientation of the image sensor accordingly to retain a given direction, including vertical distortion correction;
A lens assembly, comprising:
A rotational mechanism configured to allow the lens assembly to rotate independently of the camera body;
A sliding mechanism configured to adjust the position of the lens assembly along the optical axis to align the focal plane with the tilted image sensor;
Wherein the movement of the lens assembly is defined by a set of mathematical relationships described in the section “Formulas,” ensuring that the rotation and sliding motion maintain alignment of the focal plane with the tilted sensor.

2. Partially Motorized Variation of the Device for Perspective Control Using a Rotating Image Sensor and Rotating & Sliding Lens Assembly
A camera system for perspective control, utilizing combination of motorized and manual movement control, comprising:
A tiltable image sensor, configured to rotate around a single axis to maintain a desired orientation for composition control or perspective distortion correction;
A user-controlled rotation process, wherein the photographer manually rotates the camera body around a second axis to achieve a desired orientation for composition control or perspective distortion correction;
A lens assembly, comprising:
A rotational mechanism configured to rotate the lens assembly independently of the camera body along the axis of the same direction as axis of the image sensor;
A sliding mechanism configured to adjust the position of the lens assembly along the optical axis to align the focal plane with the tilted sensor;
Wherein the movement of the lens assembly is defined by a set of mathematical relationships described in the section “Formulas,” ensuring that the rotation and sliding motion maintain alignment of the focal plane with the tilted sensor;
A circular image sensor, configured such that at each sensor tilt position, a square capture area is selected within the circular sensor to maintain a consistent image area, wherein the orientation change of the square capture area is represented by an angle epsilon (ε) and its mathematical relationships are described in the section “Formulas”;
Wherein computational adjustment is applied to translate the rotated pixel grid of the image sensor to align with the horizontal and vertical grid of displays.

3. A Lens Assembly with U-Shaped Cut for Size and Weight Optimization
A lens assembly for use in a tiltable image sensor system, comprising:
A primary optical body, configured to project an image onto an image sensor;
Wherein the lens assembly is modified by selectively removing material from opposite sides of the optical body, such that:
The cut follows a U-shaped profile, corresponding to the outline path of light traveling through the assembly;
The modification is based on the required projection area, which takes the shape of a long rectangle, making the opposing sides of the lens assembly unnecessary;
The resulting shape reduces the overall size and weight of the lens assembly while maintaining sufficient optical coverage for the image sensor.
